(19) United States
(12) Patent Application Publication
(10) Pub. No.: US 2015/0275719 A1
(43) Pub. Date: Oct. 1, 2015

(54) DEVICE FOR PROCESSING BLOW-BY FROM V-TYPE INTERNAL COMBUSTION ENGINES

(71) Applicant: NISSAN MOTOR CO., LTD., Yokohama-shi, Kanagawa (JP)

(72) Inventors: Shunsuke Nakama, Yokohama-shi (JP); Nobuhito Arai, Yokohama-shi (JP); Takahiro Ohnishi, Fukui-shi (JP)

(73) Assignee: NISSAN MOTOR CO., LTD., Yokohama-shi, Kanagawa (JP)

(21) Appl. No.: 14/428,703

(22) PCT Filed: Oct. 1, 2013
(86) PCT No.: PCT/JP2013/076684

§ 371 Date: Mar. 17, 2015

(30) Foreign Application Priority Data
Oct. 2, 2012 (JP) 2012-219943

(51) Int. Cl. F01M 13/04; F02M 25/06; F01M 13/02; F02B 75/22

(52) U.S. Cl. CPC F01M 13/04; F02B 75/22; F02M 25/06; F01M 13/022

(57) ABSTRACT

An object of the invention is to improve space efficiency, while ensuring a desired blow-by gas processing performance. As gas routes that connect a crankcase and each of intake passages, a first gas route and a second gas route connected to respective throttle upstream parts of the intake passages on the upstream side of each throttle valve for each bank, and a third gas route connected to a throttle downstream part of the intake passage for one of the banks are provided. Separators are disposed in the respective gas routes, for separating oil mist from blow-by gas. Only the first separator having a comparatively large capacity is disposed in the first bank on the side where a crankshaft rotates upward from the bottom. The second and third separators are both juxtaposed to each other in the second bank on the side where the crankshaft rotates downward from the top.

### TECHNICAL FIELD

The present invention relates to a device for processing blow-by from a V-type internal combustion engine. Background Art

As is generally known, a blow-by processing device is provided for processing blow-by gases leaked from combustion chambers of an internal combustion engine into a crankcase (see Patent document 1). The blow-by processing device is configured for introducing fresh air through a fresh-air introduction gas route, which is connected to the throttle upstream part of an intake passage, into the crankcase for ventilation, and for supplying blow-by gases in the crankcase through a blow-by gas reflux gas route, which is connected to the throttle downstream part of the intake passage, into the intake passage and for returning back into the combustion chambers for combustion processing. Also provided is a PCV (positive crankcase ventilation) valve installed in the blow-by gas reflux gas route for adjusting or regulating the rate of blow-by gas flow. By the way, once the amount of blow-by exceeds the flow rate of the PCV valve in a high load range, the excess blow-by gases are also allowed to be supplied via the fresh-air introduction gas route into the intake passage.

Also, to prevent oil (oil mist) in blow-by gases from being carried or pulled into the intake system, separators (oil separators) are disposed or arranged in the respective gas routes for separating oil mist in the blow-by gases.

### CITATION LIST

### Patent Literature

Patent document 1: Japanese Patent Provisional Publication No. 2008-267214

### SUMMARY OF THE INVENTION

### Technical Problem

In the case of V-type internal combustion engines, fresh-air introduction gas routes (a first gas route and a second gas route) are provided in respective banks, whereas a blow-by gas reflux gas route (a third gas route), which is connected to the throttle downstream part of an intake passage, and a PCV valve are both used in common for the two banks. This contributes to reduced number of component parts and simplification.

However, when arranging separators in respective gas routes, it is difficult to secure arranging spaces for the respective separators. In particular, to clear exhaust gas regulations in recent years, on V-type internal combustion engines, in addition to these separators, a lot of devices such as fuel-system pipes, an air-control device, cooling-system pipes and the like have to be installed or arranged. This leads to strictly-limited space requirements. For instance, securing or utilizing the limited space between two banks as arranging spaces for respective separators is troublesome.

It is, therefore, in view of the previously-described drawbacks, in a blow-by processing device of a V-type internal combustion engine configured such that separators are provided in three gas routes respectively, an object of the invention to achieve improved mountability and downsizing by optimizing the layout of the three separators, taking into account a direction of rotation of a crankshaft and by efficiently arranging the three separators in banks without sacrificing a desired blow-by processing performance.

### Solution to Problem

A blow-by processing device according to the present invention is applied to a V-type internal combustion engine having a first bank and a second bank, arranged at a predetermined bank angle to each other. As gas routes that connect a crankcase and each of intake passages, three gas routes, that is, a first gas route that connects the crankcase and a throttle upstream part of the intake passage for the first bank, a second gas route that connects the crankcase and a throttle upstream part of the intake passage for the second bank, and a third gas route that connects the crankcase and a throttle downstream part of the intake passage for one of the two banks are provided. A first separator, a second separator, and a third separator, each of which has a function that separates oil mist from blow-by gas, are interposed in the first gas route, the second gas route, and the third gas route, respectively.

By the way, in the first bank arranged on a side where a crankshaft rotates upward from a bottom, rotary motion of the crankshaft causes an upward airflow directed from the crankcase toward the first separator. Owing to such an upward airflow serving as a resistance, oil, captured by the first separator, is hard to be returned through the first gas route back into the crankcase. The oil is more apt to be stored in the first separator and the first gas route. Therefore, to ensure or maintain a desired blow-by processing performance (oil discharge performance and oil separability), a large capacity is required by the first separator.

Conversely, in the second bank arranged on a side where the crankshaft rotates downward from a top, rotary motion of the crankshaft causes a downward airflow directed from the second separator toward the crankcase. By the aid of such a downward airflow, oil, captured by the second separator, is apt to be returned through the second gas route back into the crankcase. The oil is less apt to be stored, and thus it is possible to ensure a desired oil separability and oil discharge performance, in spite of a comparatively small separator capacity.

Hence, according to the present invention, only the first separator is disposed in the first bank of the two banks, namely, the first bank and the second bank, the first bank being arranged on the side where the crankshaft rotates upward from the bottom. On the other hand, the second separator and the third separator are both disposed in the second bank and placed in juxtaposition with each other, the second bank being arranged on the side where the crankshaft rotates downward from the top.

On one hand, by disposing only the first separator on the side where the crankshaft rotates upward from the bottom, that is, in the first bank in which oil is hard to be returned toward a lower oil pan, a large capacity is secured by the first separator, and thus it is possible to ensure or maintain a desired blow-by processing performance (oil discharge performance and oil separability). On the other hand, by disposing both the second separator and the third separator in juxtaposition with each other on the side where the crankshaft rotates downward from the top, that is, in the second bank in which oil is apt to be returned, it is possible to intensively dispose the third separator in the banks in the same manner as the first and second separators, while ensuring or maintaining a desired blow-by processing performance. Hence, there is no necessity of disposing the third separator in the limited space between the two banks, or in a location defined outside of the banks. This contributes to the improved space efficiency and improved mountability.

### Advantageous Effects of Invention

As discussed above, according to the invention, it is possible to compatibly achieve ensuring of blow-by processing performance and improved mountability, by optimizing the layout of three separators, taking into account a direction of rotation of a crankshaft.

### BRIEF DESCRIPTION OF DRAWINGS

FIG. 1 is an explanatory drawing illustrating an embodiment of a blow-by processing device according to the invention for processing blow-by from an internal combustion engine, and showing gas flow in a low load range.

FIG. 2 is an explanatory drawing illustrating the blow-by processing device of the embodiment for processing blow-by from the internal combustion engine, and showing gas flow in a high load range.

FIG. 3 is a view, in partial cross-section, of the internal combustion engine of the embodiment.

FIG. 4 is an explanatory drawing illustrating a range of formation of a separator in the first bank.

FIG. 5 is an explanatory drawing illustrating a range of formation of each of separators in the second bank.

FIG. 6 is an explanatory diagram illustrating a flow-rate characteristic of a PCV valve.

FIG. 7 is an explanatory diagram illustrating a flow-rate characteristic of the first separator.

FIG. 8 is an explanatory diagram illustrating a flow-rate characteristic of the second separator.

### DESCRIPTION OF EMBODIMENTS

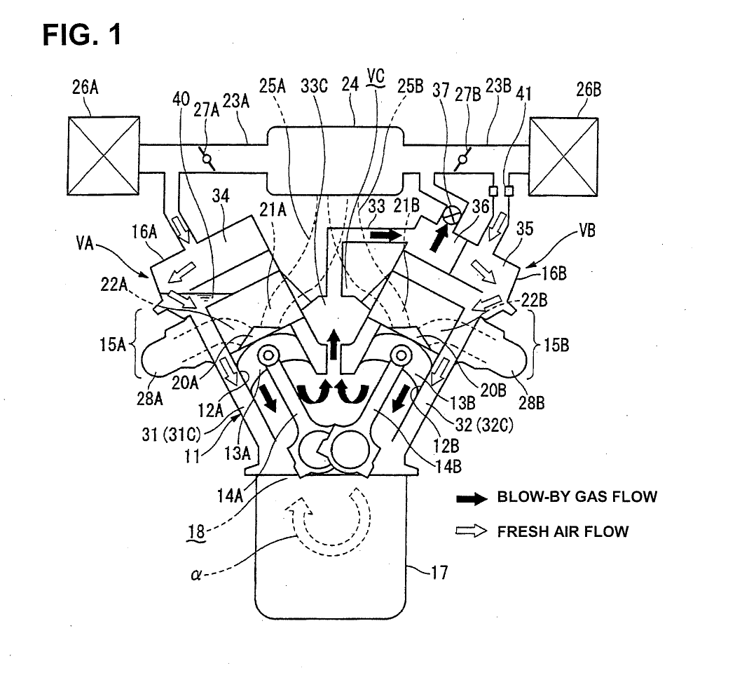

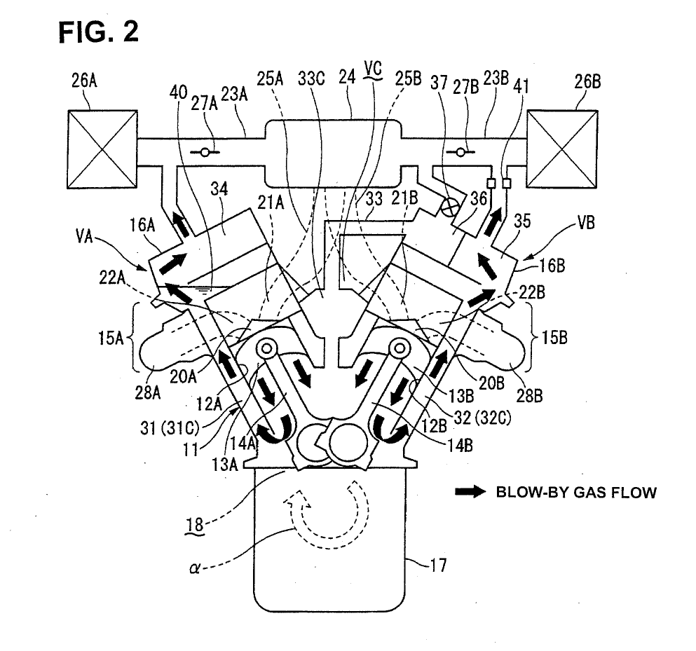

The present invention is hereinafter described in reference to the drawings illustrating the embodiment. FIGS. 1 and 2 are the schematic drawings illustrating the system configuration of the blow-by processing device of the embodiment for processing blow-by from a V-type internal combustion engine to which the invention can be applied. FIG. 1 shows blow-by gas flow and fresh-air flow in a low load range, whereas FIG. 2 shows blow-by gas flow in a high load range.

In the V-type internal combustion engine, a first bank VA and a second bank VB are arranged at a predetermined bank angle. In the following discussion, the same reference signs used to designate elements shown in the first bank will be applied to the corresponding elements shown in the second bank, and also for the purpose of discrimination between the two banks, the character “A” is added to indicate components arranged in the first bank VA, whereas the character “B” is added to indicate components arranged in the second bank VB.

Engine cylinders 12A and 12B are formed in a cylinder block 11 and arranged at the predetermined bank angle. Pistons 13A and 13B are fitted into respective cylinders 12A and 12B such that reciprocating motion of each of the pistons is permitted. A crankshaft (not shown) is rotatably supported by the cylinder block 11 and located at the lower section of each of cylinders 12A and 12B. Crankpins of the crankshaft are connected to respective pistons 13A and 13B through connecting rods 14A and 14B.

Cylinder heads 15A and 15B are fixedly connected to the upper section of cylinder block 11 and provided for each of banks VA and VB. Head covers 16A and 16B are attached or fixedly connected onto respective upsides of cylinder heads 15A and 15B. An oil pan 17 is attached to the lower section of cylinder block 11 for storing engine oil. A crankcase 18 is formed or defined inside of both the cylinder block 11 and the oil pan 17 in a fluid-tight fashion. The crankcase acts as a space for accommodating therein the crankshaft. By the way, the direction denoted by the symbol “a” in the drawings indicates denotes a direction of rotation of the crankshaft.

Pent-roof shaped combustion chambers 20A and 20B are formed for each individual engine cylinder in each cylinder head 15A, 15B for each bank. Intake ports and exhaust ports are also formed or configured in the respective cylinder heads such that intake port 21A and exhaust port 22A are connected to the combustion chamber 20A, and that intake port 21B and exhaust port 22B are connected to the combustion chamber 20B. Although it is not clearly shown in the drawings, intake valves are installed for opening and closing respective intake ports 21A and 21B, whereas exhaust valves are installed for opening and closing respective exhaust valves 22A and 22B.

Intake pipes 23A and 23B, a single intake collector 24, and intake manifolds 25A and 25B are provided in the intake system, which constructs the intake passages of the internal combustion engine. The intake pipes are provided in respective banks VA and VB. The intake pipes of both banks VA and VB are configured to be connected to the single intake collector. The intake manifolds are configured to connect the intake collector 24 and respective intake ports 21A and 21B of both banks VA and VB. Air cleaners 26A, 26B and electronically-controlled throttle valves 27A, 27B are disposed in respective intake pipes 23A and 23B of banks VA and VB, and arranged in that order from the upstream side. The air cleaners are provided for purifying or removing foreign matter (impurities) from intake air. The electronically-controlled throttle valves are provided for adjusting the quantity of intake air. The operation of each of throttle valves 27A, 27B is controlled depending on an engine operating condition by means of a control unit (not shown).

As an exhaust system of the internal combustion engine, exhaust manifolds 28A and 28B are mounted on respective cylinder heads 15A and 15B of the banks, and connected to respective exhaust ports 22A and 22B.

The blow-by processing device, which constructs an essential part of the present embodiment, is hereinafter described in detail. As gas routes that connect the crankcase 18 and each of the intake passages defined in intake pipes 23A, 23B, a first gas route 31 that connects the inside of crankcase 18 and the throttle upstream part of the intake passage defined in the intake pipe 23A for the first bank VA on the upstream side of throttle valve 27A, a second gas route 32 that connects the inside of crankcase 18 and the throttle upstream part of the intake passage defined in the intake pipe 23B for the second bank VB on the upstream side of throttle valve 27B, and a third gas route 33 that connects the inside of crankcase 18 and the downstream part of the intake passage for one of the banks (concretely, the second bank VB) on the downstream side of the throttle valve (concretely, throttle valve 27B) are provided.

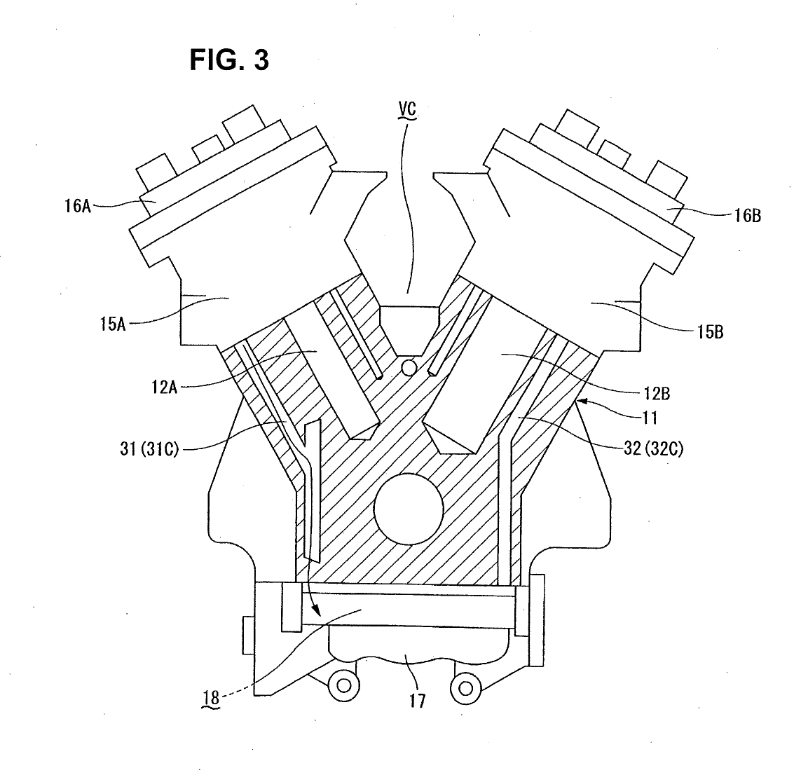

A first separator 34, a second separator 35, and a third separator 36, each of which has a function that separates oil mist from blow-by gas, are disposed in respective gas routes 31-33. The construction of each of separators 34-36 is generally known, and hereunder described briefly. For instance, gas-liquid separation is carried out by bringing blow-by gases, flown into each of separators 34-36 and containing oil mist, into collision with a collision plate. These separators are configured to return the separated oil mists through respective gas routes 31-33 back into the oil pan that forms the lower part of crankcase 18. In more detail, as shown in FIGS. 1-3, communication passages 31C, 32C are formed near the respective sidewalls of cylinder block 11 so as to construct a portion of the first gas route 31 and a portion of the second gas route 32, respectively. The first communication passage is configured to connect the first separator 34 and the crankcase 18, whereas the second communication passage is configured to connect the second separator 35 and the crankcase 18. These communication passages 31C, 32C serve as oil-return passages that return oil, captured by the separators 34-36, back to the oil pan.

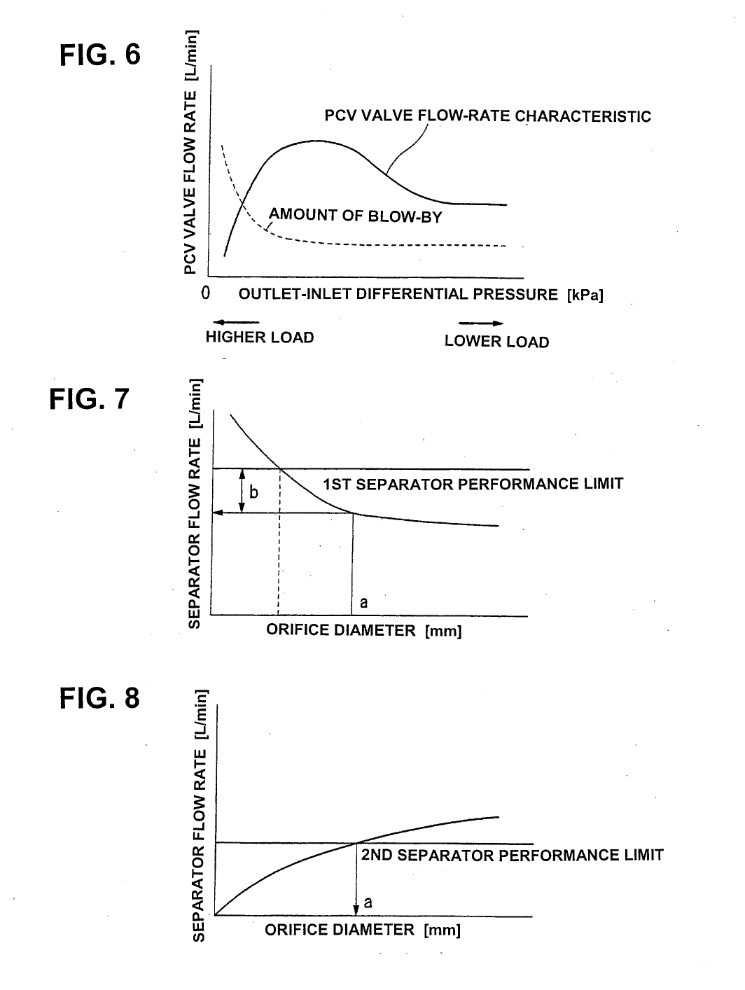

A PCV valve 37 is interposed in a portion of the third gas route 33 that connects the third separator 36 and the throttle downstream part of the intake passage for the second bank VB, for adjusting the flow rate of blow-by gas. Referring to FIG. 6, there is shown the flow-rate characteristic of PCV valve 37. The term “OUTLET-INLET DIFFERENTIAL PRESSURE” in this diagram means the differential pressure between an inlet part of each of the first and second gas routes 31, 32 connected to the respective throttle upstream parts of the intake passages and an outlet part of the third gas route 33 connected to the throttle downstream part of the intake passage. As the engine load decreases, the negative pressure in the throttle downstream part develops and thus the outlet-inlet differential pressure also increases. As clearly shown in the diagram, the PCV-valve flow-rate characteristic is set such that on the low load side the flow rate of PCV valve 37 exceeds the blow-by gas flow rate (i.e., the amount of blow-by), and that on the high load side the blow-by gas flow rate exceeds the flow rate of PCV valve 37.

FIG. 1 shows blow-by gas flow (indicated by the blackened arrow) and fresh-air flow (indicated by the voided arrow) in a low load range. As shown in the drawing, in the low load range, fresh air is introduced into the crankcase 18 by way of the throttle upstream parts of the intake passages via the first gas route 31 and the second gas route 32 for fresh-air introduction. Hence, the interior of crankcase 18 is ventilated. Blow-by gases in the crankcase 18 are supplied through the third gas route serving as the blow-by gas reflux gas route into the throttle downstream part of the intake passage, and then burned in the combustion chambers 20A, 20B.

FIG. 2 shows blow-by gas flow (indicated by the blackened arrow) in a high load range. As shown in the drawing, in the high load range, the blow-by gas flow rate exceeds the flow rate of PCV valve 37, and thus the excess blow-by gases in excess of the flow rate of PCV valve 37 are supplied through the first gas route 31 and the second gas route 32 into the throttle upstream parts of the intake passages, and then burned in the combustion chambers 20A, 20B. In this manner, in the high load range, the blow-by gas flow toward the first and second gas routes 31, 32 for fresh-air introduction occurs. Hence, the first separator 34 and the second separator 35 are disposed in these gas routes 31, 32, respectively.

In the present embodiment, only the first separator 34 is disposed in the first bank VA of the two banks, namely, the first bank VA and the second bank VB, the first bank being arranged on the side where the crankshaft rotates upward from the bottom. On the other hand, the second separator 35 and the third separator 36 are both disposed in the second bank VB and placed in juxtaposition with each other, the second bank being arranged on the side where the crankshaft rotates downward from the top.

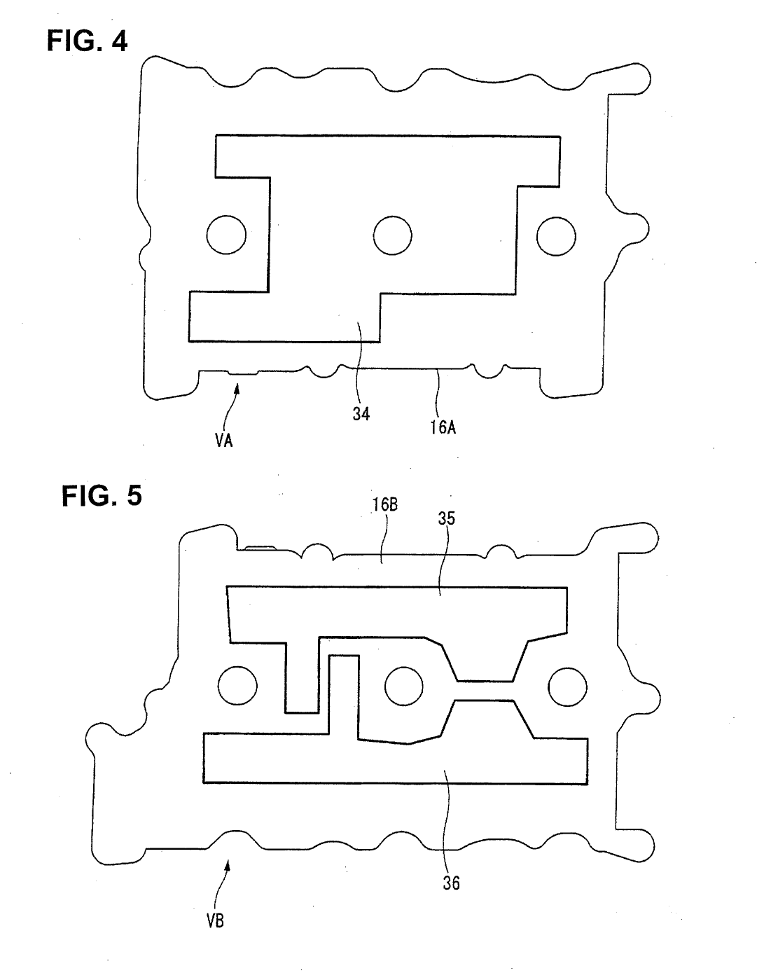

FIG. 4 schematically shows the range of formation of the first separator 34 formed inside of the head cover 16A of the first bank VA, whereas FIG. 5 schematically shows the range of formation of each of the second and third separators 35, 36 formed inside of the head cover 16B of the second bank VB. As shown in FIG. 5, in the second bank VB, the second separator 35 is located near the outside of the second bank and arranged along the cylinder-row direction. Also, the third separator 36 is placed in juxtaposition with the second separator 35, and located near the inside of the second bank, and arranged along the cylinder-row direction. In contrast to this, as shown in FIG. 4, in the first bank VA, the first separator 34 is arranged to extend over a wide range of formation from the inside of the first bank to the outside of the first bank. Therefore, the capacity of the first separator 34 is set to be sufficiently greater than that of the second separator 35 (than that of the third separator 36).

In the first bank VA arranged on the side where the crankshaft rotates upward from the bottom, rotary motion of the crankshaft causes an upward airflow directed from the crankcase 18 toward the first separator 34 in the communication passage 31C of the first gas route 31 that connects the crankcase 18 and the first separator 34. Owing to the upward airflow serving as a resistance, oil, captured by the first separator 34, is hard to be returned back into the crankcase. As indicated by reference sign 40 in FIGS. 1-2, the oil is apt to be stored or accumulated in the first separator 34 and the first route 31. For the reasons discussed above, to ensure a desired oil separability and oil discharge performance, a comparatively large capacity is required by the first separator 34.

Hence, in the shown embodiment, only the first separator 34 is disposed in the first bank VA, which is arranged on the side where the crankshaft rotates upward from the bottom. Therefore, a sufficient capacity is secured by the first separator 34, and thus it is possible to ensure a desired oil separability and oil discharge performance.

On the other hand, in the second bank VB arranged on the side where the crankshaft rotates downward from the top, rotary motion of the crankshaft causes a downward airflow directed from the second separator 35 toward the crankcase 18 in the communication passage 32C of the second gas route 32 that connects the crankcase 18 and the second separator 35. By the aid of the downward airflow, oil, captured by the second separator 35 (and the third separator 36) is apt to be returned back into the crankcase 18. The oil is less apt to be stored or accumulated, and thus it is possible to ensure a desired oil separability and oil discharge performance, in spite of a comparatively small separator capacity.

Hence, in the shown embodiment, in the second bank VB having a high oil discharge performance, the second separator 35 and the third separator 36 are placed in juxtaposition with each other. That is, the second separator 35 is downsized as compared to the first separator 34. The third separator 36 is placed or formed in a space caused by the downsized second separator 35. Thus, it is possible to intensively dispose all the three separators 34-34 in the banks VA, VB, while a desired blow-by processing performance. Hence, there is no necessity of disposing the third separator 36 in the limited space between the banks or in a location defined outside of the banks. This contributes to the superior space efficiency, thereby greatly improving the mountability.

As discussed above, in the shown embodiment, it is possible to compatibly achieve ensuring of blow-by processing performance and improved mountability at a high level, by optimally arranging the three separators in the banks VA, VB, taking into account the rotation direction a of the crankshaft.

Also, in the shown embodiment, to optimize the ratio between the flow rate of the first separator 34 having a large capacity and the flow rate of the second separator 35 having a small capacity, as shown in FIGS. 1-2, an orifice 41 is placed in the second gas route 32 for limiting or restricting the flow rate. More concretely, as shown in FIGS. 1-2, orifice 41 is placed at a portion of the second gas route 32 that connects the second separator 35 and the throttle upstream part of the intake passage, for partially narrowing or constricting the fluid-flow passage area. By the way, orifice 41 may be placed in a pipe of head cover 16B. Alternatively, the orifice may be installed or placed in a blow-by hose that connects the pipe of the head cover and the intake pipe 23B.

FIG. 7 shows the flow-rate characteristic of the first separator 34, whereas FIG. 8 shows the flow-rate characteristic of the second separator 35. As seen from the these diagrams, by setting the orifice diameter at a predetermined value “a”, the performance limit flow rate of the second separator 35 is set lower than the performance limit flow rate of the first separator by a flow rate difference “b”. As discussed above, by virtue of such a simple configuration that uses the orifice 41, the ratio between the flow rates of the first separator 34 and the second separator 35 whose capacities differ from each other can be optimized. Hence, depending on the two different capacities of the first separator 34 and the second separator 35, the flow rates of these separators can be appropriately distributed. Therefore, even though the capacities of the first separator 34 and the second separator 35 differ from each other, a desired oil separability can be obtained for each of the first separator 34 and the second separator 35.

Furthermore, in the shown embodiment, as shown in FIGS. 1-2, the third separator 36 is located at a portion of the second bank VB near the inside section of the second bank with respect to the second separator 35, while the third gas route 33 is arranged and placed, utilizing an inter-bank space VC, which is a dead space defined between the banks. That is to say, as a part of the third gas route 33, an inter-bank passage 33C is provided in the inter-bank space VC for connecting the crankcase 18 and the third separator 36. By virtue of the previously-discussed placement of the third gas route 33 utilizing the inter-bank space VC, the space efficiency can be improved. By virtue of arrangement of the third gas route 33 in the inter-bank space VC positioned just above the crankcase 18, it is possible to directly take out blow-by gases through a short route from the crankcase 18. This contributes to shortening of gas route 33 and improved blow-by processing performance.

1. (canceled)

2. A blow-by gas processing device of a V-type internal combustion engine having a first bank and a second bank arranged in a predetermined bank angle to each other, and a crankcase arranged below both of the banks and adapted to accommodate a crankshaft, comprising:
a first gas route configured to connect the crankcase and a throttle upstream part of an intake passage for the first bank;
a second gas route configured to connect the crankcase and a throttle upstream part of an intake passage for the second bank;
a third gas route configured to connect the crankcase and a throttle downstream part of the intake passage of one of the two banks;
a first separator interposed in the first gas route and having a function that separates oil mist from blow-by gas;
a second separator interposed in the second gas route and having a function that separates oil mist from blow-by gas; and
a third separator interposed in the third gas route and having a function that separates oil mist from blow-by gas,
wherein the first separator is disposed in the first bank of the two banks, the first bank being arranged on a side where the crankshaft rotates upward from a bottom;
wherein the second separator and the third separator are both disposed in the second bank arranged on a side where the crankshaft rotates downward from a top, and placed in juxtaposition with each other; and
wherein a capacity of the first separator is set to be greater than a capacity of the second separator.

3. A blow-by gas processing device of a V-type internal combustion engine as recited in claim 2, wherein:
an orifice is disposed in the second gas route for restricting a flow rate of the second gas route less than a flow rate of the first gas route.

4. A blow-by gas processing device of a V-type internal combustion engine as recited in claim 2, wherein:
the third separator is located near an inside section of the second bank with respect to the second separator; and
the third gas route is disposed in an inter-bank space defined between the banks so as to provide an inter-bank passage for connecting the crankcase and the third separator.

5. A blow-by gas processing device of a V-type internal combustion engine as recited in claim 2, wherein:
a PCV valve is interposed in a portion of the third gas route that connects the third separator and the throttle downstream part of the intake passage for the second bank, for adjusting a flow rate of blow-by gas.

6. A blow-by gas processing device of a V-type internal combustion engine as recited in claim 5, wherein:
a flow path that permits fresh air to be introduced from the throttle upstream parts of the intake passages through the first gas route and the second gas route into the crankcase and a flow path that permits blow-by gas in the crankcase to be supplied through the third gas route into the throttle downstream part of the intake passage are configured in a low load range; and
a flow path that permits the blow-by gas in the crankcase to be supplied through the first gas route and the second gas route into the throttle upstream parts of the intake passages is configured in a high load range.
